(19) United States
(12) Patent Application Publication
(10) Pub. No.: US 2016/0080155 A1
(43) Pub. Date: Mar. 17, 2016

(54) Systems and Methods for Controlling the Distribution, Processing, and Revealing of Hidden Portions of Images

(71) Applicant: Peeqsee, Inc., La Canada Flintridge, CA (US)

(72) Inventors: Vacit Arat, La Canada Flintridge, CA (US); Scott Thomas Sullivan, La Canada Flintridge, CA (US); Jeffrey Stuart, Santa Rosa, CA (US)

(73) Assignee: Peeqsee, Inc., La Canada Flintridge, CA (US)

(21) Appl. No.: 14/853,794

(22) Filed: Sep. 14, 2015

Related U.S. Application Data
(60) Provisional application No. 62/050,047, filed on Sep. 12, 2014.

(51) Int. Cl. H04L 9/32; G06T 5/50; G06F 3/0481

(52) U.S. Cl. CPC H04L 9/3239; G06F 3/0481; G06T 5/50; H04L 2209/16

(57) ABSTRACT

Concealed image control (CIP) systems in accordance with various embodiments of the invention control the distribution, concealment, and revealing of hidden images and obscurants. The hidden portions of images can be hidden by obscurants (also referred to herein as “peeqs”) that can be removed when an attempt to view the hidden portion of the images is approved by an originator of the hidden image. CIP systems can provide for a graphical user interface control scheme by which originators of images can place constraints on the delivery of portions of obscured images on remote user devices. CIP systems can utilize interactions between multiple electronic devices to ensure secure concealment and controlled revealing of hidden portions of images. CIP systems can further provide verification of the appropriateness of altered, original, and hidden images.

### CROSS-REFERENCE TO RELATED APPLICATIONS

The present application claims priority under 35 U.S.C. §119(e) to U.S. Provisional Patent Application Ser. No. 62/050,047 entitled “Permission Based Revealing of Images and Other Media” filed Sep. 12, 2014. The disclosure of U.S. Provisional Patent Application Ser. No. 62/050,047 is hereby incorporated by reference in its entirety.

### FIELD OF THE INVENTION

The present invention generally relates to graphical user interfaces and control systems for the remote managing, concealment, and display of hidden portions of images.

### BACKGROUND

Graphical user interfaces can enable human interaction with electronic devices through many graphical elements. Graphical user interfaces can include text, icons, windows, images, and moveable graphics. The technical field of graphical user interface design is continuously improving, with new elements and interactive means being generated in many new applications. Graphical user interfaces are typically defined by computer programmers and application developers prior to installation of the software supporting said graphical user interfaces. Users of applications have some customization options, but cannot affect the interfaces of other users of other applications. Moreover, the technical field of image processing and management intersects with the technical field of graphical user interface design. Improved image management tools are being continuously develop to further the fields of image processing and management.

### SUMMARY OF THE INVENTION

Concealed image control (CIP) systems in accordance with various embodiments of the invention control the distribution, concealment, and revealing of hidden images and obscurants. The hidden portions of images can be hidden by obscurants (also referred to herein as “peeqs”) that can be removed when an attempt to view the hidden portion of the images is approved by an originator of the hidden image. CIP systems can provide for a graphical user interface control scheme by which originators of images can place constraints on the delivery of portions of obscured images on remote user devices. CIP systems can utilize interactions between multiple electronic devices to ensure secure concealment and controlled revealing of hidden portions of images. CIP systems can further provide verification of the appropriateness of altered, original, and hidden images.

One embodiment of the method of the invention includes: providing an image processing graphical user interface on an originator device using a concealed image processing system, receiving a designation of a concealed portion of an original image to conceal through the provided graphical user interface at the originator device using the concealed image processing system, generating an altered image based on the received designation using the concealed image processing system, where the altered image includes an obscurant that conceals and replaces the concealed portion of the original image, distributing the altered image including the obscurant to a viewer device using the concealed image processing system, where the concealed portion of the original image remains on originator device, and receiving an indication of an attempt to view the concealed portion of the original image from the viewer device using the concealed image processing system. When approval of the attempt to view is received from the originator device, the method screens the concealed portion of the original image for inappropriate content using the concealed image processing system and transmits the concealed portion of the original image to the viewer device using the concealed image processing system. Upon receipt of the transmitted concealed portion of the original image, the original image is reconstituted and displayed on the viewer device using the concealed image processing system.

In a yet further embodiment, the attempt to view includes an indication on a graphical user interface that is displaying the altered image on the viewer device.

In a further embodiment again, the concealed image processing system encrypts the altered image according to a first asymmetric key using, and the altered image is decrypted prior to viewing using a second asymmetric key stored on the viewer device.

In a further embodiment, the concealed image processing system encrypts the concealed portion of the original image prior to transmission to the viewer device using a symmetric key.

In yet another additional embodiment, where the original image is a single frame of a video that includes a set of images, and the concealed image processing system further generates an altered set of images based on the received designation, and the altered set of images includes at least one obscurant that conceals and replaces portions of each of the set of images.

In still another further embodiment, the concealed image processing system receives a set of constraints and transmission of the concealed portion of the original image to the viewer device only occurs after satisfactions of the set of constraints. In another further embodiment, the set of constrains includes at least one of: a minimum threshold of attempts to view across a set of viewer devices, a limitation on viewing at only a particular time period, and/or a limitation on viewing to only when a viewer device is at a particular location.

In still another embodiment, the concealed image processing system further logs activities of the concealed image processing system. In a still further additional embodiment, the logged activities include a count of attempts to view received

In another embodiment, the concealed image processing system further captures the original image using image capture components of the originator device.

One embodiment of an image processing system includes at least one processing unit and a memory storing an image processing application. The memory storing the image processing application directs the at least one processing unit to: receive an altered image including an obscurant that conceals a designated portion of an original image, where the concealed portion of the original image was designated on a graphical user interface of an originator device, where the concealed portion of the original image remains on originator device; distribute the altered image including the obscurant to a viewer device; and receive an indication of an attempt to view the concealed portion of the original image from the viewer device. When approval of the attempt to view is received the originator device, the image processing application directs the at least one processing unit to: screen the concealed portion of the original image for inappropriate content and transmit the concealed portion of the original image to the viewer device using the concealed image processing system, where upon receipt of the transmitted concealed portion of the original image at the viewer device, the viewer device reconstitutes and displays the original image.

In still another additional embodiment, the attempt to view includes an indication on a graphical user interface that is displaying the altered image on the viewer device.

In a yet further embodiment again, the image processing application further directs the at least one processing unit to encrypt the altered image according to a first asymmetric key, where the altered image is decrypted prior to viewing using a second asymmetric key stored on the viewer device.

In a still further embodiment, the image processing application further directs the at least one processing unit to encrypt the concealed portion of the original image prior to transmission to the viewer device using a symmetric key.

In yet a further additional embodiment, the original image is a single frame of a video that includes a set of images, where the altered image is a part of an altered set of images, and where the altered set of images includes at least one obscurant that conceals and replaces portions of each of the set of images.

A further additional embodiment also includes where the image processing application further directs the at least one processing unit to: receive a set of constraints; and where transmission of the concealed portion of the original image to the viewer device only occurs after satisfactions of the set of constraints. Another additional embodiment also includes where the set of constrains includes at least one of: a minimum threshold of attempts to view across a set of viewer devices, a limitation on viewing at only a particular time period, and/or a limitation on viewing to only when a viewer device is at a particular location.

A still yet further embodiment also includes where the image processing application further directs the at least one processing unit to log activities of the image processing system. In still yet another embodiment, the logged activities include a count of attempts to view received.

In another additional embodiment again, the image processing application further directs the at least one processing unit to capture the original image using image capture components of the originator device.

### BRIEF DESCRIPTION OF THE DRAWINGS

FIG. 1 is a network diagram illustrating a concealed image control (CIP) system in accordance with an embodiment of the invention.

FIG. 2 is a flow chart illustrating a process for processing hidden images utilizing a CIP system in accordance with an embodiment of the invention.

FIG. 3 is a flow chart illustrating a process for processing hidden images utilizing a CIP system in accordance with an embodiment of the invention.

FIG. 4A is a conceptual illustration demonstrating obfuscation and reveal operations performed by a CIP system in accordance with an embodiment of the invention.

FIG. 4B is a conceptual illustration demonstrating obfuscation and reveal operations performed by a CIP system in accordance with an embodiment of the invention.

FIG. 5 conceptually illustrates an architecture of an originator device in accordance with an embodiment of the invention.

FIG. 6 conceptually illustrates an architecture of a, operator process server in accordance with an embodiment of the invention.

FIG. 7 conceptually illustrates an architecture of a viewer device in accordance with an embodiment of the invention.

### DETAILED DESCRIPTION

Turning now to the drawings, concealed image control (CIP) systems configured to processing images for concealment, distribution, and controlled revealing of hidden and/or obscured portions images in accordance with various embodiments of the invention are illustrated. CIP systems can provide for a graphical user interface control scheme by which originators of images can place constraints on the delivery of portions of the images on remote user devices. CIP systems can utilize interactions between multiple electronic devices to ensure secure concealment and controlled revealing of hidden portions of images. The hidden portions of images can be hidden by obscurants (also referred to herein as “peeqs”) that can be removed when an attempt to view the hidden portion of the images is approved by an originator of the hidden image. These hidden portions of images and/or partly obscured visual media (images, videos. etc.) can be used in social networking platforms, photo/video sharing apps and advertisements to arouse the curiosity of the viewers. Viewers using viewer devices can attempt to view hidden images behind obscurants. Several embodiments provide for additional functionalities based on attempts to view hidden images, such as utilizing the attempts to view as means to enter lotteries, prize contests and/or sweepstakes.

CIP systems can include several electronic devices working in concert to provide remote control of hidden images. For instance, some embodiments can include an originator device, an operator device, and a viewing device. The originator device is typically a mobile and/or imaging device that provides functions for receiving an image and concealing portions of said image. The originator device communicates with the operator device. The operator device communicates with both the originator device and the viewer device to coordinate attempts to view by the viewer device and granting permissions to view hidden and/or obscured images according to inputs to the originator device. Communications between the several electronic devices can be facilities by CIP Apps installed on some or all of the devices of a CIP system.

Viewers can interact with hidden portions of images via graphical user interface elements provided by viewer devices, such as mouse-clickable obscurants on electronic displays or touchable elements on the displays of touch screen devices (e.g. tapping, swiping, scratching motion that emulates an eraser, etc.). Upon such interactions, the viewer device can communicate with the operator device and receive permission to cause the obscurant to disappear and the hidden image to be revealed on the viewer device. The hidden images can be securely stored on originator devices until attempts to view are approved by user(s) of the originator devices. By enabling secure remote control of the viewing of hidden portions of images, the invention provides for improvements to the technical fields of user interface design and image processing. Additional means of controlling the distribution of images are provided that thereby provide for better functioning of computing systems reliant on user interfaces to control image management.

Moreover, further permission management and viewing control functions are provided by embodiments of the invention. Operator devices can provide statistics and notifications to originator devices so that users of the originator devices know who has expressed a desire to view hidden and/or obscured images, and then provide for control over which viewers will be granted permission to view the hidden and/or obscured images. In order to secure hidden and/or obscured images against any possibility of theft, hacker penetration, and/or premature release at the Originator device(s) or the Operator device(s), embodiments of the invention can limit locations at which the hidden and/or obscured images are stored. For instance, operator device(s) typically do not store the hidden portion of the images and only receive them upon receipt of an approval (from an originator device) of an attempt to view by a viewing device. Embodiments can further provide for encryption techniques to secure hidden images from early access or hacking penetration. Some embodiments can perform a screening function at the operator device(s) to detect certain images that should be controlled (pornography, criminal content, copyright violations, etc.) while minimizing data processing and data transfers of hidden and/or obscured images. To balance goals of hidden image security with requirements to protect against potentially criminal content, embodiments of the invention can minimize or even eliminate possession of the hidden and/or obscured portions of images by maintaining possession solely within the originator device(s) until attempts to view have been approved by users of the originator device(s).

Having discussed a brief overview of the operations and functionalities CIP systems in accordance with many embodiments of the invention, a definitions section followed by a more detailed discussion of system and methods for CIP systems in accordance with embodiments of the invention follows below.

### Definitions of Terms Related to Concealed Image Control Systems

In order to clarify the operations of CIP systems in accordance with embodiments of the invention, the following passage detail definitions for terms used in herein. The following definitions are provided by general guidance, and some embodiments may deviate and/or include different features from the terms recited herein.

“Devices” can include internet-connected computing devices including (but not limited to) a smart phone, a tablet, personal computer, a wearable device, a server computer, and any other device capable of executing applications for supporting operations performed by CIP systems in accordance with embodiments of the invention. Where devices are qualified as operator devices, originator devices, and/or viewer devices; these devices can be included (or not included) as necessary for implementation of the invention as part of CIP systems.

“CIP app” includes application software that runs on a CIP system device the primary functionality of which is to obscure portions of images; share such images with others, and reveal the obscured portions of the images through an operator-managed system of permissions and authentications.

“Operator devices” can include any device executing an application that provides a cloud server (or any other type of server) that perform at least one of the following operations: communicate with installations of the CIP app over the internet; coordinate and run the distribution of the media and related content between the users of the CIP app; screen the media for inappropriate content; and maintain a database that records interactions between various devices of the CIP system.

“Images” can include electronic image files including (but not limited to) pictures, frames of video, bitmap images, jpeg images, and/or any other electronic display capable graphics.

“Obscurants” can include visual masks of any kind that blocks at least a portion of an original image from viewing. The obscurant may be as simple as a plain color mask. It may also be any other image with pictures, a photo, text, shapes, logos; a special visual effect such as a blurred version of the image underneath; a video or some other type of animation such as keyframe animation; or any combination of the above.

“Obscurant data” can include all of the information related to an obscurant; including as appropriate the pixel map, commands to the CIP app to perform certain functions, and data on such functions.

“Originator devices” can include any device an installation of the CIP app. The CIP app on the originator devices can enable users of the originator devices to obscure a portion of an image, and share it with others.

“Viewer devices” can include any device with an installation of the CIP app on his/her device, who receives an image from the originator, and is expected to make an attempt to see behind the obscurant user any user of the CIP app—an originator or a viewer

“Original image” can include the original raw image with no obscurants placed on it yet. Original image data contains a list of the pixels of the original image with values assigned to each pixel.

“Altered images” can include images that have been obscured by obscurants according to instructions received by an originator device. Altered images are displayed on viewer devices with obscurants obscuring at least a portion of the original image.

“Hidden images” or “concealed images” can include the underlying images that contain the original image pixel data of the pixel locations behind the obscurants. When used herein, the terms hidden images and concealed images can be used interchangeably. Hidden images can contain the location coordinates of the obscurants, and the data for each pixel in that region which corresponds to each coordinate. There may be multiple sets of hidden images corresponding to multiple obscurants.

“Attempt to view” can include operations that communicate intent to the CIP app installed on a viewer device to view what is concealed by an obscurant. This may be in the form of clicking on the obscurant; if using touchscreen device, the user of the viewer device may touch the obscurant on the screen in some fashion (e.g. Tapping, swiping, scratching motion that emulates an eraser, etc.). This may also be in the form of some other interaction with the device such as shaking the device; making audible sounds (e.g. “open sesame!”), or presenting the viewer device an image through the viewer device's camera which can be processed as part of an authentication system.

“Constraints” may include any combination of the following conditions (but are not limited to the conditions listed): the identities of people allowed to view hidden images; viewing hidden images for a limited period (e.g. X seconds) followed by obscuring of the hidden images again; viewing hidden images only if the viewing device is at a particular location; viewing hidden images only at a particular date/time window; viewing hidden images only if certain additional authentication is verified (voice/face recognition, etc.); viewing hidden images only if the right attempt to view is received; unmasking the obscurant with a specific special effect (e.g. Fade slowly; cross-fade; use a sound effect, emulate fireworks, play an animation or a video, etc.); treating the viewing act as a hotlink and perform the functions dictated by that link; viewing only after a request to view is sent to an originator device, and the originator device specifically grants the request; view only after a minimum threshold of the number of requests is received. In addition, viewing can be constrained such that stepped viewing is initiated at every attempt to view (i.e., more revealed at every new attempt to view) according to the following operations: remove a part of the obscurant (e.g. Shrink the obscurant by a percentage); go from completely opaque to 100% transparent in steps; and allow moving the obscurant around from its fixed position to reveal more of the hidden image underneath.

### Network Architectures for Concealed Image Control Systems

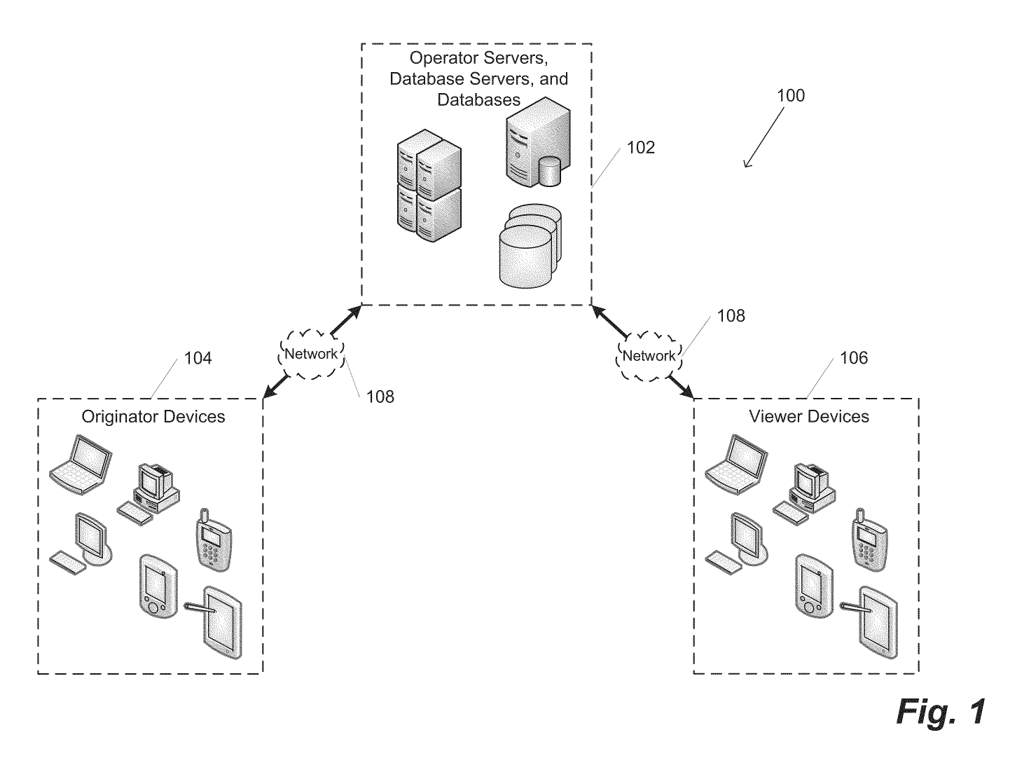

A network architecture for a concealed image control system for manage the concealment, distribution, and controlled revealing of hidden and/or obscured images in accordance with an embodiment of the invention is illustrated in FIG. 1. CIP system 100 includes operator devices 102 that include operator servers, database servers, and databases. Operator devices 102 can also include (but is not limited to) distributed cloud based server systems. The operator devices 102 can communicate over network 108 with several groups of devices in order to facilitate the origination, distribution, and revealing of concealed images. The groups of devices include (but are not limited to) originator devices 104, and/or viewer devices 106. As illustrated in FIG. 1, Operator devices 102 include application servers, database servers, and databases. In various embodiments, Operator devices 102 can include varying numbers and types of devices. For instance, Operator devices 102 can be implemented as a single computing device where the single computing device has sufficient storage, networking, and/or computing power. However, Operator devices 102 may also be implemented using multiple computing devices of various types and multiple locations. While Operator devices 102 is shown including application servers, database servers, and databases, a person skilled in the art will recognize that the invention is not limited to the devices shown in FIG. 1 and can include additional types of computing devices (e.g., web servers, and/or cloud storage systems). The Operator devices 102 can further perform operations including (but not limited to) communicating with installations of CIP Apps on originator devices 104, and/or viewer devices 106, coordinating and running distribution of obscured (i.e., altered) images and related content between originator devices 104, and/or viewer devices 106, screening images for inappropriate content, and/or maintaining databases that record activity between the CIP processing 102 and other devices.

In the embodiment illustrated in FIG. 1, network 108 is the Internet. Operator devices 102 communicate with originator devices 104, and/or viewer devices 106 through network 108. Network 108 can include wireless connections such as (but not limited to) a 4G connection, a cellular network, a Bluetooth connection, a Wi-Fi network, a Wi-Fi hotspot, a kiosk, a beacon, and/or any other wireless data communication link appropriate to the requirements of specific applications. Other embodiments may use other networks, such as Ethernet or virtual networks, to communicate between devices. A person skilled in the art will recognize that the invention is not limited to the network types shown in FIG. 1 and can include additional types of networks (e.g., intranets, virtual networks, mobile networks, and/or other networks appropriate to the requirements of specific applications).

Originator devices 104, and/or viewer devices 106 can include many different kinds of devices. For instance, originator devices 104, and/or viewer devices 106 can include end machines including (but not limited to) desktop computers, laptop computers, and/or virtual machines. Moreover, originator devices 104, and/or viewer devices 106 can include mobile devices including (but not limited to) cellular phones, laptop computers, smart phones, and/or tablet computers).

Although a specific architecture is shown in FIG. 1, different architectures involving electronic devices and network communications can be utilized to implement CIP systems to perform operations and provide functionalities in accordance with embodiments of the invention. The operations performed and supported by Operator devices 102, originator devices 104, and/or viewer devices 106 will be discussed in more detail in conjunction with the flow charts and examples that follow FIG. 1.

### Overview of Operations of Concealed Image Processing Systems

The following passages will detail flowcharts describing the operations of embodiments of the invention according to different perspectives. The perspective presented are not limiting such to preclude distribution of the operations recited to different devices within concealed image processing systems of varying embodiments. Rather, these are exemplary operation flows from representative device implementations in accordance with embodiments of the invention.

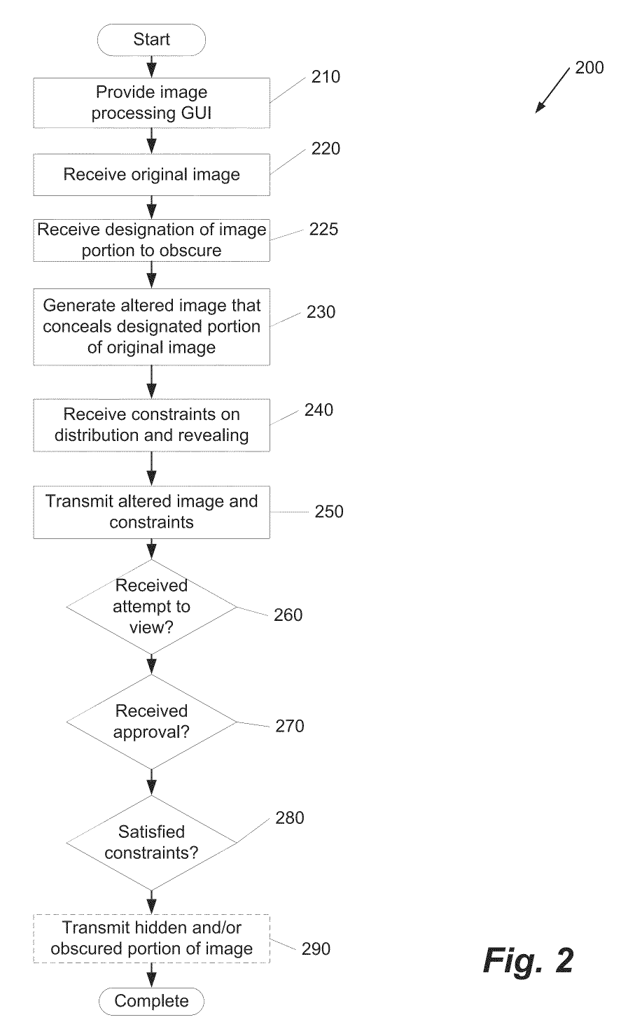

FIG. 2 conceptually illustrates a process 200 performed by CIP systems in accordance with embodiments of the invention in processing concealed images and managing controlled revealing of hidden images from the perspective of an originator device. In a number of embodiments, the process 200 is performed by an originator device of a CIP system in accordance with the embodiment described above in connection with FIG. 1. The process 200 can include providing (210) an image processing graphical user interface (GUI). The image processing GUI can receive inputs from users to facilitate the operations described as a part of process 200. Users can interact and designate hidden portions of images via graphical user interface elements provided by process 200, such as mouse-clickable obscurants on electronic displays or touchable elements on the displays of touch screen devices (e.g. tapping, swiping, scratching motion that emulates an eraser, etc.). Other embodiments may utilize other GUIs and/or applications to support designation of portions of images to be concealed and particular obscurants with which to conceal said images. In many embodiments, devices involved in process 200 can have instances of CIP Apps installed and in network communication to support secure generation and distribution of concealed images.

The process 200 can receive (220) an original image. The original image can be received from many different sources, including (but not limited to) from a camera installed on a viewer device, from a database of images, from a social media website, from a remote source on the internet, from a digital camera, from a cloud storage facility, and/or any other electronic means of receiving an image. Where the originator device is a desktop, laptop, mobile device and/or any other computing device, saved images may be available from non-transitory memories on the device. In embodiments that will be discussed in further detail below, the original image can also be an image from a set of images from a video and/or multimedia presentation.

The process 200 can receive (225) a designation of a portion of the original image to obscure. This can be accomplished via interaction with the provided image processing GUI. Typically, an area will be selected on the original image. Often, this selected area will be a particularly interesting portion of the original image. The area can be of varying shapes and sizes. The designation can further define an obscurant to be placed over the designated area. The obscurants can include visual masks of any kind that blocks at least a portion of an original Image from viewing (such as a pixel graph). The obscurants may also be any other image with pictures, text, shapes, logos; a special visual effect such as a blurred version of the image underneath; a video or some other type of animation such as key frame animation; or any combination of the above. Moreover, there can be multiple obscurants over a single image and/or multiple obscurants distributed across multiple images in different embodiments.

The process 200 can generate (230) an altered image that conceals the designated portion of the original image. The concealed portion can be defined according to inputs to the provided GUI. The altered image (i.e., obscured image) can include obscurants that block a portion of the altered image from view. Some embodiments provide for certain logos and/or activity indicators as a part of the obscurants. The obscured portion of the generated altered image can be referred to as a hidden image or a concealed image. The altered images can be generated on originator devices in some embodiments. In these embodiments, the originator devices do not transmit the hidden portion of the altered images to the operator devices until certain conditions have been satisfied. These conditions can include approval of attempts to view by users of the originator devices and/or satisfaction of constraints by viewer devices (said constraints supplied by the originator devices). Thereby these embodiments of the invention ensure that the altered, concealed, and/or hidden portions of images remain securely on originator devices. In some embodiments, the original image can be a complex image comprising links and/or user interface elements. Where the original image is a complex image, obscurants can be designated and defined over the links and/or user interface elements. The resulting altered images can have the links and/or user interface elements removed. The links and/or user interface elements can be restored upon their transmission along with hidden and/or concealed portions of the original complex image.

The process 200 can receive constraints (240) on the distribution and revealing of concealed images within the altered images. The constraints can define how process 200 will elect to release hidden images for display on viewer devices. The constraints can be received by originator devices and be defined by users entering constraint definitions to graphical user interfaces provided by the originator devices. Constraints can include conditions dictated to the graphical user interface of an originator device under which any obscurant can be removed. Constraints can be defined in instructions listed in a file maintained by CIP systems performing process 200. Constraints may include any combination of the following conditions (but are not limited to the conditions listed): the identities of people allowed to view hidden images; viewing hidden images for a limited period (e.g. X seconds) followed by obscuring of the hidden images again; viewing hidden images only if the viewing device is at a particular location; viewing hidden images only at a particular date/time window; viewing hidden images only if certain additional authentication is verified (voice/face recognition, etc.); viewing hidden images only if the right attempt to view is received; unmasking the obscurant with a specific special effect (e.g. Fade slowly; cross-fade; use a sound effect, emulate fireworks, play an animation or a video, etc.); treating the viewing act as a hotlink and perform the functions dictated by that link; viewing only after a request to view is sent to an originator device, and the originator device specifically grants the request; view only after a minimum threshold of the number of requests is received. In addition, viewing can be constrained such that stepped viewing is initiated at every attempt to view (i.e., more revealed at every new attempt to view) according to the following operations: remove a part of the obscurant (e.g. Shrink the obscurant by a percentage); go from completely opaque to 100% transparent in steps; and allow moving the obscurant around from its fixed position to reveal more of the hidden image underneath.

The process 200 can transmit (250) the altered images and constraints. Typically, the altered images and constraints on the altered images are provided from originator devices to operator devices. The operator devices can perform several operations that will be discussed in detail in conjunction with further figures. The altered image can further be made available to viewer devices via internet connections between originator devices, operator devices, and/or viewer devices. The altered images and constraints can be transmitted over various networks to reach viewer devices as required to implement the invention. Examples of networks usable by the invention and process 200 are discussed above in connection with CIP system 100 of FIG. 1. In some embodiments the altered image is provided to viewer devices running a CIP App from operator devices. In these embodiments, the operator devices maintain databases and cloud databases for supporting large scale image distribution numerous remote and mobile viewer devices. The originator devices, operator devices, and/or viewer devices together can form a concealed image processing system.

Process 200 can make several decisions based on whether certain conditions have been satisfied for hidden image receipt and distribution. Process 200 waits until an attempt to view has been received (260). Attempts to view can include operations that communicate intent to the CIP app installed on a device to view portions of an altered image concealed by an obscurant. This may be in the form of a graphical user interface input to a viewer device (such as a tap on a touch screen viewer device that is displaying the altered image). Upon receipt of an attempt to view, process 200 determines whether approval has been received (270). Approval can be received from input to interfaces on originator devices. Typically, the user who originated the altered image will also be the user who provides approval for distribution of the concealed portion of the altered image. Moreover, the particular originator device is usually the same originator device from which approval is received and the altered image originated. Varying embodiments may provide for varying method of receiving approval for release of the concealed portion of an altered image. Depending on the quantity and type of viewer devices, different means of providing approval may be provided. For instance, some embodiments provide for an “approve all” user interface element to indicate approval of all viewer devices to view the hidden portions of the certain altered images. Other approval interface elements may also be provided, such as a “approve single viewer” element that accepts designations of particular users. Process 200 then checks whether received constraints are satisfied (280). As discussed above, many different constraints can be received and varying conditions will have to be satisfied. The process can either wait or terminate should approval of an attempt to view or constraints fail to be satisfied.

When the above discussed decisions are in the affirmative, process 200 can optionally transmit (290) hidden and/or obscured portions of the original image. Typically, the hidden and/or obscured portions are maintained on originator devices. Thus, the hidden and/or obscured portions of the original image may be first transmitted at this stage from the originator devices to the operator devices and/or viewer devices. Transmission of hidden and/or obscured portions of images may involve transmission from the originator devices, to the operator devices, and then further to the downstream viewer devices that attempted to view the hidden and/or obscured portions of images and met conditions associated with certain constraints. In some embodiments, devices involved in the transmission of concealed images will have CIP Apps installed and in communication to securely transmit concealed images. Upon receipt of hidden and/or obscured images, a CIP App running on a receiving viewer device can verify that any constraints associated with the received hidden and/or obscured images are satisfied prior to display of the hidden and/or obscured images.

While the operations described as part of process 200 were presented in the order as they appeared in the embodiment illustrated in FIG. 2, various embodiments of the invention perform the operations of process 200 in different orders as required to implement the invention. For instance, in some embodiments, constraint receipt, altered image generation, and transmission occur in different orders. Having discussed operations of a CIP system from an originator device perspective, the following figure presents operations from the perspective of an operator device.

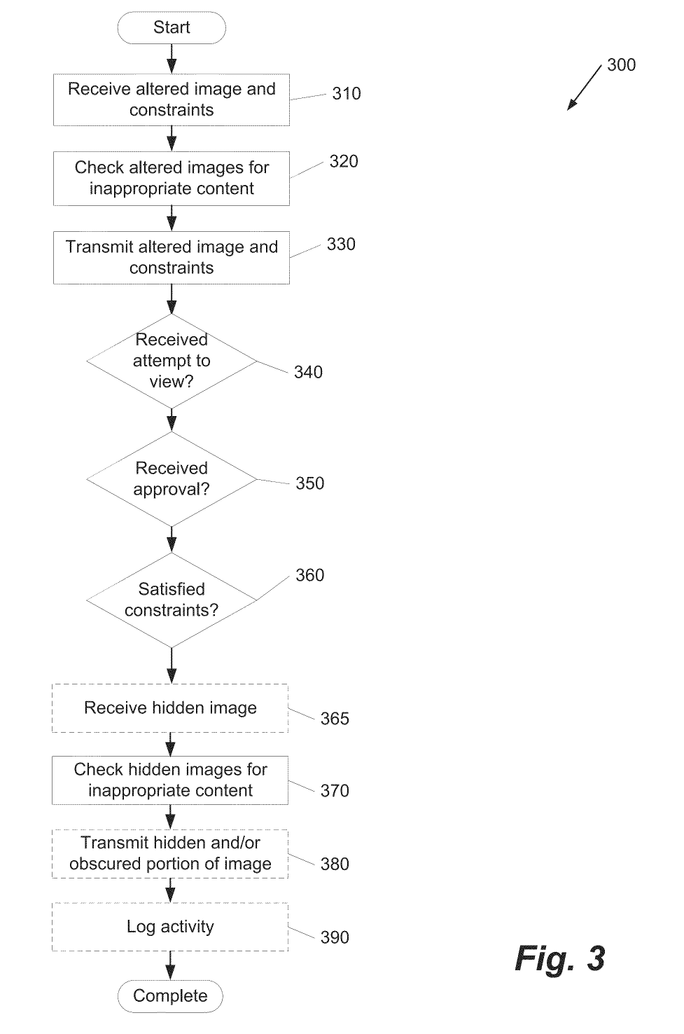

FIG. 3 conceptually illustrates a process 300 performed by CIP systems in accordance with embodiments of the invention in processing concealed images and managing controlled revealing of hidden images from the perspective of an operator device. In a number of embodiments, the process 300 is performed by an operator device of a CIP system in accordance with the embodiment described above in connection with FIG. 1. As mentioned above, operating devices can be servers and database systems in singular machines, distributed systems, virtual machines, and/or cloud server. In many embodiments, devices involved in process 300 can have instances of CIP Apps installed and in network communication to support secure generation and distribution of concealed images.

The process 300 can include receiving (310) altered images and constraints on their revealing and distribution. The altered images can be generated by and received from originator devices. The altered images can include obscurants obscuring certain portions of the altered images, thereby concealing portions of the altered images. The altered images typically do not include the concealed portions of the altered images. The received constraints and examples thereof are discussed extensively above. Upon receipt of the altered image, the operator devices, in performing process 300, may check (320) altered images for inappropriate content (e.g., pornography, copyright violations, illegal images, etc.). Where the altered image contains inappropriate content, the process 300 ends.

The process 300 can transmit (330) the altered image and received constraints to viewer devices. The viewer devices can then view the altered image along with the obscurants concealing the hidden and/or concealed portion of the altered image. When viewed, the obscurants present the opportunity for users of the viewer devices to attempt to view the obscured portions of the image. This can be accomplished by input to a graphical user interface provided by the viewer devices. Attempts to view (e.g., clicking on the obscurant) can be indicated to the operator device via communication between CIP Apps running on the viewer devices.

Process 300 can make several decisions based on whether certain conditions have been satisfied for hidden image receipt and distribution. Process 300 waits until an attempt to view has been received (340). Attempts to view can include operations that communicate intent to the CIP app installed on a device to view portions of an altered image concealed by an obscurant. This may be in the form of a graphical user interface input (such as a tap on a touch screen device). Upon receipt of an attempt to view, process 300 determines whether approval has been received (350). Approval can be received from input to interfaces on originator devices. The approval can be received remotely from originator devices by operator devices performing process 300. Typically, the user who originated the altered image will also be the user who provides approval for distribution of the concealed portion of the altered image. Varying embodiments may provide for varying method of receiving approval for release of the concealed portion of an altered image. Process 300 then checks whether received constraints are satisfied (360). The operator device performing process 300 may evaluate the conditions itself, or in the alternative the operator device can receive indication of constraint satisfaction from viewer and/or originator devices. As discussed above, many different constraints can be received and varying conditions will have to be satisfied. The process can either wait or terminate should approval of an attempt to view or constraints fail to be satisfied.

When the above discussed decisions (approval of attempt to view and constraint satisfaction) are in the affirmative, process 300 can optionally receive (365) hidden and/or obscured portions of the original image. The hidden and/or obscured portions of the original image are typically received from an originator device. Thus, the hidden and/or obscured portions of the original image may be first received by a device besides the originator device upon which it was obscured at this stage. Upon receipt of the hidden and/or obscured portions of the original image, the operator devices, in performing process 300, may optionally check (370) images for inappropriate content (e.g., pornography, copyright violations, illegal images, etc.). Where the hidden and/or obscured portions of the original image contain inappropriate content, the process 300 ends.

The process can optionally transmit (380) hidden and/or obscured portions of the original image to viewer devices. This transmission can be contingent upon selective approval of certain viewer devices for approval. Selective approval can be indicated by data received from originator devices. Upon transmission, a CIP App running on the receiving viewer device can verify that any constraints associated with the transmitted hidden and/or obscured image are satisfied prior to display of the hidden and/or obscured image. The process 300 can further optionally log activity. The activities logged can include (but are not limited to) number of attempts to view, number of downloads, identities of users and/or viewer devices attempting to view images, numbers of transmissions, types of obscurants, constraint satisfaction counts, times involved in transmission and display of altered images, and/or other data involved in facilitating processing of concealed images. The logging of activities can be utilized by operator systems to confirm revealing of obscured images and can also indicate times of revealed images. Moreover, in some embodiments logged data can be shared between operator and originator devices.

While the operations described as part of process 300 were presented in the order as they appeared in the embodiment illustrated in FIG. 3, various embodiments of the invention perform the operations of process 300 in different orders as required to implement the invention. For instance, in some embodiments, inappropriate content screening can occur at different times as is more efficient for distribution.

In some embodiments, the original image can be a complex image comprising links and/or user interface elements. Where the original image is a complex image, obscurants can be designated and defined over the links and/or user interface elements. The resulting altered images can have the links and/or user interface elements removed. The links and/or user interface elements can be restored upon their transmission along with hidden and/or concealed portions of the original complex image.

While many of the embodiments discussed above relate to still images, further embodiments can provide for obscurants appearing over frames of video in a video and/or multimedia presentation. Varying embodiments can provide for obscurants over the same location in every frame of video, or in different frames of video. In addition, different obscurants may appear and disappear throughout a video at a same or at varying locations of the screen. Moreover, an obscurant can move around to cover a particular moving object in a video and/or multimedia presentation. Attempts to view can be linked to a play button in some of the video embodiments. Where video obscurants are supported, CIP Apps in accordance with embodiments of the invention can provide for a video editing interface to place obscurants on portions of video and/or multimedia presentations. Hidden and/or concealed portions of video and/or multimedia presentations can be processed utilizing CIP systems and applications in analogous manners to the processes described above in connection with FIG. 2 and FIG. 3. Specifically, process 200 and process 300 are not limited to still obscured images and can be generalized to apply to obscured video. Having discussed several operational flow charts, the following discussion will present several examples and screenshots of concealed image processing systems in action.

### Examples of Concealed Image Processing Systems in Operation

The following section presents several examples of CIP systems and applications in operation. These examples are presented as conceptual illustrations of particular embodiments of the invention. Other embodiments may deviate from the specific interfaces, operations and phase orders presented in connection with the following example figures and remain in accordance with the invention. For example, CIP systems can include many more devices and many different types of devices than those shown in following figures. In addition, different GUI elements may be present in different embodiments.

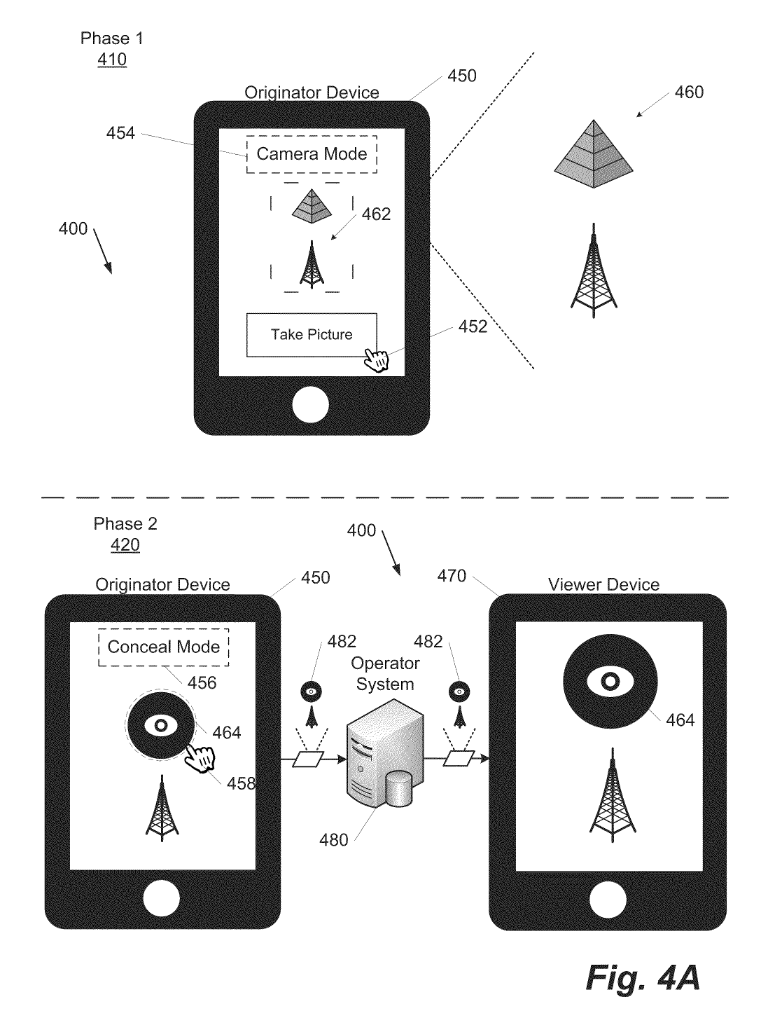

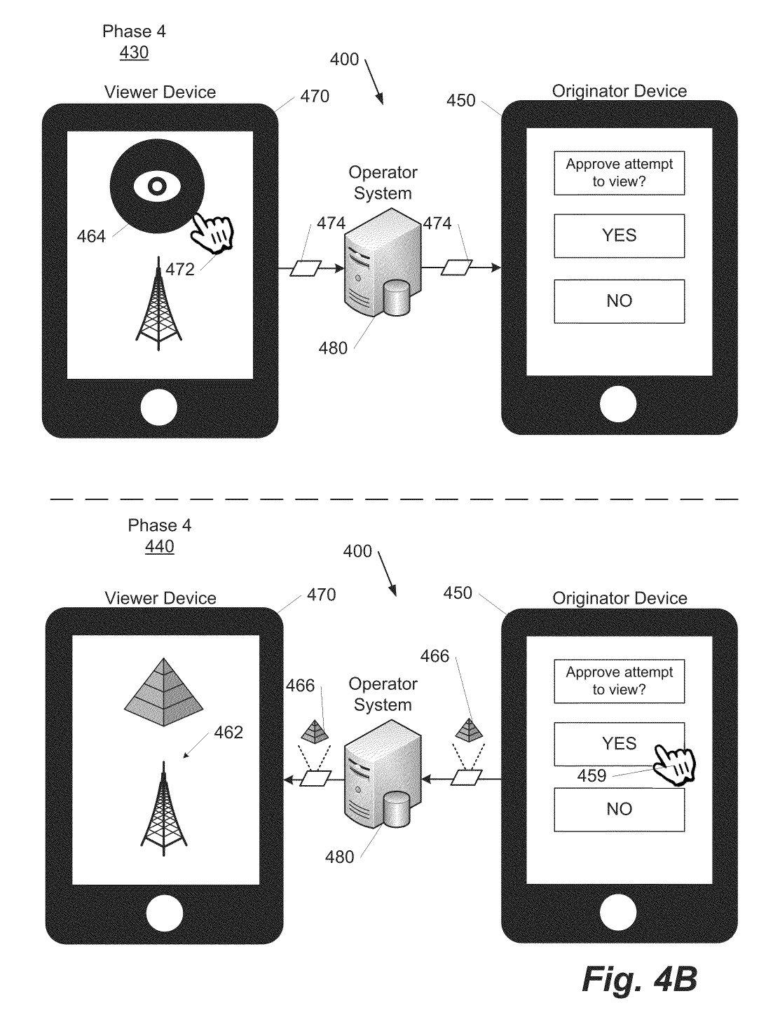

FIG. 4A and FIG. 4B conceptually illustrates four stages of a concealed image processing system 400 performing operations associated with an embodiment of the invention. These stages serve visual representations of graphical user interface elements of various devices of CIP system 400 as an image is captured, obscured, transmitted, attempted to be viewed, hidden image final transmission, and revealing on a viewer device. CIP system includes originator device 450, viewer device 470, and operator system 480. Both originator device 450 and viewer device 470 are mobile devices with touch screen interfaces, while operator system 480 is a server and database system. The devices shown in each phase are the same devices between phases where they are labeled with a same identifying number. The example in FIG. 4A and FIG. 4B is only one example of a CIP system in accordance with one embodiment of the invention.

Beginning with FIG. 4A, phase 1 410 shows originator device in camera mode 0354 taking a picture of a scene 460. As shown, scene 460 includes a tower and a pyramid. A user of originator device 450 is applying input 452 to the take a picture button to capture an image of scene 460. Originator device 450 shows a display of captured image 462 of scene 460.

Phase 2 420 shows several operations. First, phase 2 420 shows originator device 450 in conceal mode 456 receiving input 458 to conceal a portion of the captured image 462. As shown, obscurant 464 is being placed over the pyramid of captured image 462 according to input 458. Second, phase 2 420 shows originator device 450 transmitting altered image 482 to operator system 480 and operator system 480 transmitting altered image 482 to viewer device 470. Viewer device 470 can be seen displaying altered image 482 with the pyramid obscured by obscurant 464. The obscured image can arouse curiosity in the viewer who may wish to view what is beneath the obscurant. While the obscurant 464 suggests that a hidden image is underneath, in fact, no such hidden image has been transmitted yet. The transmitted altered image 482 is in fact completely altered by the obscurant 464. The pixels of the pyramid from captured image 462 are entirely replaced by the obscurant 464 and the operator system 480 and viewer device 470 will not receive pixels showing the pyramid. This arrangement protects against early release and/or hacking penetration of altered image 462.

In FIG. 4B, phase 3 430 shows viewer device 470 displaying altered image 482 with the pyramid obscured by obscurant 464 (as noted above, the pyramid pixels have not actually been transmitted in phase 3 430). As shown, a user of viewer device 470 is applying input 472 to the obscurant 464 concealing the pyramid. In the embodiment shown, this input to the GUI of viewer device 470 can be interpreted by CIP system 400 as an attempt to view the hidden portion of captured image 462. As shown, view device transmits data 474 indicating the attempt to view to operator system 480 which further transmits data 474 indicating the attempt to view to originator device 450. Originator device 450 then displays an interface prompt querying a user whether the attempt to view is approved. Different embodiments may display different interfaces and prompts.

In phase 4 440, a user of the originator device 460 is applying input 459 to the YES button in the interface provided by originator device 450. Other embodiments may support additional control over which attempts to view are approved (such as having an “approve all” or “approve these” buttons for approving certain users and/or viewer devices). Also shown in phase 4 440, originator device 450 is transmitting hidden image 466 (the pyramid) to the operator system 480 and the operator system 480 further transmits the hidden image 466 to the viewer device 470. The hidden image 466 only leaves the originator device 450 after approval is entered at the originator device 450 in phase 4 440. Once received, the viewer device 470 then replaces the obscurant 464 with the hidden image 466, thereby reconstituting the captured image 462. The viewer device 470 then displays the complete captured image 462 with the removal of the obscurant 464 and the addition of the hidden image 466.

### Encryption and Security

In combination with or in alterative to the embodiments discussed above, the following embodiments provide for encryption and security procedures to secure hidden and/or concealed images. Some or all of the data transfers between the devices of CIP systems (e.g., originator devices, operator devices, and the viewer devices as described above) may be encrypted for additional security during transfer of data. In addition, some embodiments provide for additional assurance that the hidden and/or concealed images can only be opened at designated viewer devices by the correct party. This can be accomplished in one or a combination of the following schemes. First, when a CIP App is first installed and registered at a particular viewer device, a unique asymmetric encryption key pair is created either by the CIP App on the particular viewer device or on an operator device. The CIP App can keep a first key locked in the particular view device, and the operator device can keep a second key in a database together with that data associated with a user of the particular viewer device, and associates the other key uniquely with that user for future transactions. Whenever the operator device communicates with the originating device, the sender of the data encrypts such data using its key, and the receiver decrypts the data using the paired key in its possession. Such key pairs may be renewed from time to time. Second, critical data may be encrypted using symmetric encryption. The key for locked data at one end can be transferred to the other party at the time of request, including by using the above mentioned asymmetric encryption scheme. The invention is not limited to the preceding encryption schemes, additional embodiments may use further encryption schemes such as the advanced encryption system to secure transfers between devices of CIP systems.

### Basic Architectures for Implementing Servers for the CIP Systems of Some Embodiments

CIP systems in accordance with various embodiments of the invention rely on server hardware and/or software to be implemented. The various processes described above can be implemented using any of a variety of computing system architectures. Specific computing systems that can be utilized to implement CIP systems in accordance with embodiments of the invention and implement the various processes illustrated above are described below. While these devices are presented as physical machines, they could also be implemented as cloud servers running in virtual and/or distributed environments.

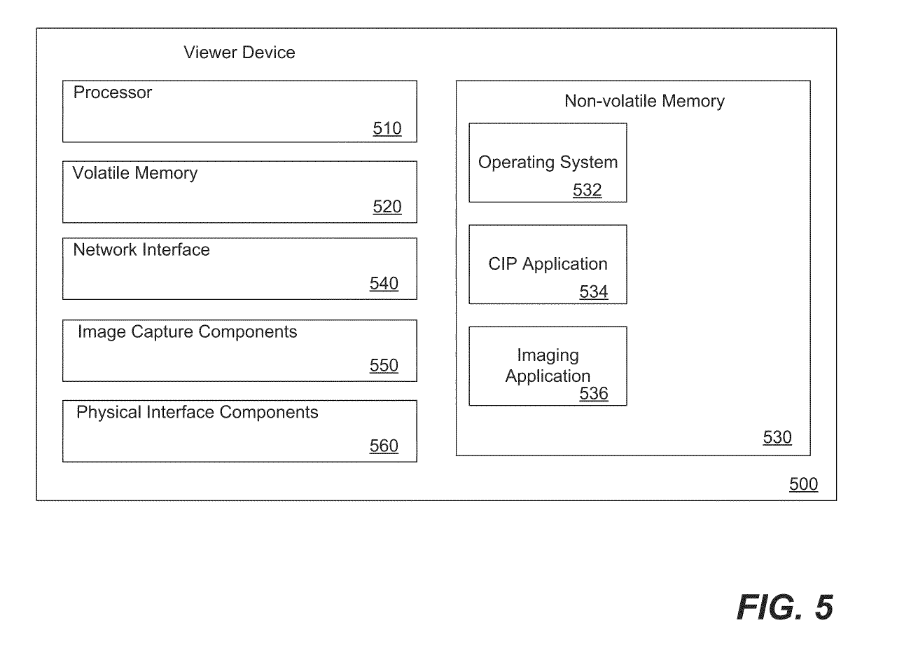

An architecture of an originator device 500 in accordance with an embodiment of the invention is illustrated in FIG. 5. The originator device 500 includes a processor 510 in communication with non-volatile memory 530, volatile memory 520, a network interface 540, image capture components 550, and physical interface components 560. Image capture components 550 can include but are not limited to cameras, lenses, focusing equipment, color balances. In the illustrated embodiment, the non-volatile memory includes an operating system 532, a CIP application 534, and an imaging application 536. The operating system 532 can manage underlying processes and hardware interactions for the originator device 500 and provide for graphical user interfaces. The CIP Application 534 can be executed to perform operations in processes described in accordance with embodiments of the invention. These operations can include (but are not limited to) receiving a designation of a portion of an image to conceal, selection and definition of an obscurant, transmission of altered images, altered image generation, selection of constraints, transmission of hidden and/or concealed images, and/or provision of GUIs for approval or disapproval of attempts to view hidden and/or concealed images. Image application 536 can provide additional and/or complementary image processing operations to CIP Application 532. These image processing operations can include (but are not limited to) image capture, camera functionality image storage, image editing, and/or image transmission. In several embodiments, the network interface 540 may be in communication with the processor 510, the volatile memory 520, and/or the non-volatile memory 530. Although a specific originator device 500 architecture is illustrated in FIG. 5, any of a variety of architectures including architectures where the CIP Application 534 is located on disk or some other form of storage and is loaded into volatile memory at runtime can be utilized to implement originator device 500 in accordance with embodiments of the invention.

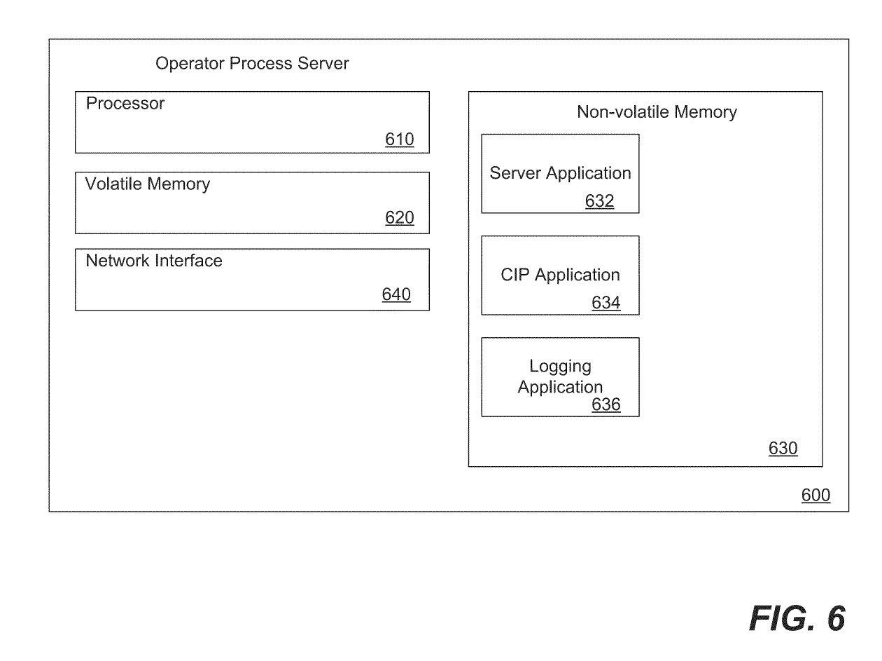

An architecture of an operator process server 600 (i.e., an operator device) in accordance with an embodiment of the invention is illustrated in FIG. 6. The operator process server 600 includes a processor 610 in communication with non-volatile memory 630, volatile memory 620, and a network interface 640. In the illustrated embodiment, the non-volatile memory includes a server application 632, a CIP application 634, and a logging application 636. The server application 632 provides the run-time, support, and/or operating systems functionality necessary to run the operator process server 600. The server application 632 can also provide for cloud management capabilities to control remove server systems and distribution of images between remote locations and/or installations of CIP Applications. The CIP Application 634 can be executed to perform operations in processes described in accordance with embodiments of the invention. These operations can include (but are not limited to) receipt of constraints and altered images, screening of content within altered and/or original images, distribution of altered and/or original images, verification of constraint satisfaction, receipt and distribution of indications of attempts to view hidden and/or concealed images, and/or logging operations. The logging application 636 can perform supplemental logging tasks to assist the CIP Application 634. In several embodiments, the network interface 640 may be in communication with the processor 610, the volatile memory 620, and/or the non-volatile memory 630. Although a specific operator process server architecture is illustrated in FIG. 6, any of a variety of architectures including architectures where the CIP Application 634 is located on disk or some other form of storage and is loaded into volatile memory at runtime can be utilized to implement operator process server in accordance with embodiments of the invention.

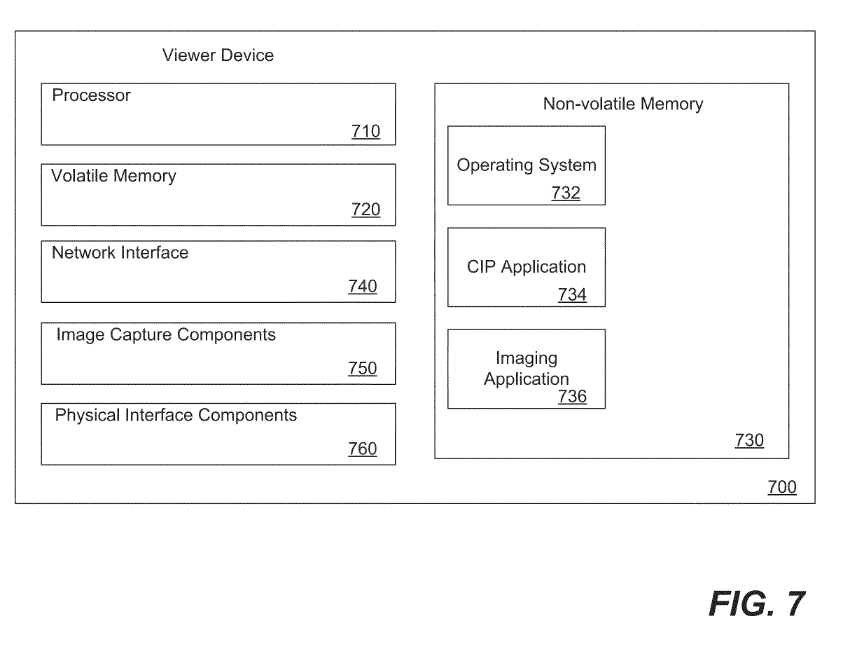

An architecture of a viewer device 700 in accordance with an embodiment of the invention is illustrated in FIG. 7. The viewer device 700 includes a processor 710 in communication with non-volatile memory 730, volatile memory 720, a network interface 740, image capture components 750, and physical interface components 760. Image capture components 750 can include but are not limited to cameras, lenses, focusing equipment, color balances. In the illustrated embodiment, the non-volatile memory includes an operating system 732, a CIP application 734, and an imaging application 736. The operating system 732 can manage underlying processes and hardware interactions for the viewer device 700 and provide for graphical user interfaces. The CIP Application 734 can be executed to perform operations in processes described in accordance with embodiments of the invention. These operations can include (but are not limited to) display of altered and/or original images, receipt of selections of images to view, transmission of indications of attempts to view hidden and/or concealed images, and/or various operations to satisfy constraints on viewing of hidden and/or concealed images. Image application 736 can provide additional and/or complementary image processing operations to CIP Application 732. These image processing operations can include (but are not limited to) image capture, camera functionality image storage, image editing, and/or image transmission. In several embodiments, the network interface 740 may be in communication with the processor 710, the volatile memory 720, and/or the non-volatile memory 730. Although a specific viewer device 700 architecture is illustrated in FIG. 7, any of a variety of architectures including architectures where the CIP Application 734 is located on disk or some other form of storage and is loaded into volatile memory at runtime can be utilized to implement viewer devices 700 in accordance with embodiments of the invention.

While the above description contains many specific embodiments of the invention, these should not be construed as limitations on the scope of the invention, but rather as various examples of particular embodiments thereof. Moreover, different embodiments of the invention can be freely combined to assist in the processing of hidden and/or concealed portions of images. Accordingly, the scope of the invention should be determined not by the embodiments illustrated, but by the appended claims and their equivalents.

What is claimed is:

1. An image processing method for controlling the concealment, distribution, and revealing of obscured images using a concealed image processing system, the method comprising:
providing an image processing graphical user interface on an originator device using a concealed image processing system;
receiving a designation of a concealed portion of an original image to conceal through the provided graphical user interface at the originator device using the concealed image processing system;
generating an altered image based on the received designation using the concealed image processing system, wherein the altered image comprises an obscurant that conceals and replaces the concealed portion of the original image;
distributing the altered image comprising the obscurant to a viewer device using the concealed image processing system, wherein the concealed portion of the original image remains on originator device;
receiving an indication of an attempt to view the concealed portion of the original image from the viewer device using the concealed image processing system;
when approval of the attempt to view is received from the originator device:
screening the concealed portion of the original image for inappropriate content using the concealed image processing system;
transmitting the concealed portion of the original image to the viewer device using the concealed image processing system; and
upon receipt of the transmitted concealed portion of the original image, reconstituting and displaying the original image on the viewer device using the concealed image processing system.

2. The image processing method of claim 1, wherein the attempt to view comprises an indication on a graphical user interface that is displaying the altered image on the viewer device.

3. The image processing method of claim 1, wherein the method further comprises encrypting the altered image according to a first asymmetric key using the concealed image processing system, wherein the altered image is decrypted prior to viewing using a second asymmetric key stored on the viewer device.

4. The image processing method of claim 1, wherein the method further comprises encrypting the concealed portion of the original image prior to transmission to the viewer device using a symmetric key and the concealed image processing system.

5. The image processing method of claim 1, wherein the original image is a single frame of a video that comprises a set of images, and wherein the method further comprises generating an altered set of images based on the received designation using the concealed image processing system, wherein the altered set of images comprises at least one obscurant that conceals and replaces portions of each of the set of images.

6. The image processing method of claim 1, wherein the method further comprises:
receiving a set of constraints; and
wherein transmission of the concealed portion of the original image to the viewer device using the concealed image processing system only occurs after satisfactions of the set of constraints.

7. The image processing method of claim 6, wherein the set of constrains comprises at least one of: a minimum threshold of attempts to view across a set of viewer devices, a limitation on viewing at only a particular time period, and/or a limitation on viewing to only when a viewer device is at a particular location.

8. The image processing method of claim 1, wherein the method further comprises logging activities of the concealed image processing system.

9. The image processing method of claim 8, wherein the logged activities comprise a count of attempts to view received.

10. The image processing method of claim 1 further comprising capturing the original image using image capture components of the originator device.

11. An image processing system for controlling the concealment, distribution, and revealing of obscured images, the system comprising:
at least one processing unit;
a memory storing an image processing application;
wherein the image processing application directs the at least one processing unit to:
receive an altered image comprising an obscurant that conceals a designated portion of an original image, wherein the concealed portion of the original image was designated on a graphical user interface of an originator device, wherein the concealed portion of the original image remains on originator device;
distribute the altered image comprising the obscurant to a viewer device;
receive an indication of an attempt to view the concealed portion of the original image from the viewer device;
when approval of the attempt to view is received the originator device:
screen the concealed portion of the original image for inappropriate content;
transmit the concealed portion of the original image to the viewer device; and
wherein upon receipt of the transmitted concealed portion of the original image at the viewer device, the viewer device reconstitutes and displays the original image.

12. The image processing system of claim 11, wherein the attempt to view comprises an indication on a graphical user interface that is displaying the altered image on the viewer device.

13. The image processing system of claim 11, wherein the image processing application further directs the at least one processing unit to encrypt the altered image according to a first asymmetric key, wherein the altered image is decrypted prior to viewing using a second asymmetric key stored on the viewer device.

14. The image processing system of claim 11, wherein the image processing application further directs the at least one processing unit to encrypt the concealed portion of the original image prior to transmission to the viewer device using a symmetric key.

15. The image processing system of claim 11, wherein the original image is a single frame of a video that comprises a set of images, wherein the altered image is a part of an altered set of images, and wherein the altered set of images comprises at least one obscurant that conceals and replaces portions of each of the set of images.

16. The image processing system of claim 1, wherein the image processing application further directs the at least one processing unit to:
receive a set of constraints; and
wherein transmission of the concealed portion of the original image to the viewer device only occurs after satisfactions of the set of constraints.

17. The image processing system of claim 16, wherein the set of constrains comprises at least one of: a minimum threshold of attempts to view across a set of viewer devices, a limitation on viewing at only a particular time period, and/or a limitation on viewing to only when a viewer device is at a particular location.

18. The image processing system of claim 11, wherein the image processing application further directs the at least one processing unit to log activities of the image processing system.

19. The image processing system of claim 18, wherein the logged activities comprise a count of attempts to view received.

20. The image processing system of claim 11, wherein the image processing application further directs the at least one processing unit to capture the original image using image capture components of the originator device.
